(19) United States
(12) Patent Application Publication
(10) Pub. No.: US 2026/0178219 A1
(43) Pub. Date: Jun. 25, 2026

(54) USING UNRELIABLE MEMORY DIES FOR ACCESS OPERATIONS

(71) Applicant: Micron Technology, Inc., Boise, ID (US)

(72) Inventors: Nicola Corna, Gorle (BG) (IT); Nicola Del Gatto, Cassina de' Pecchi (IT); Rishabh Dubey, Agrate Brianza (MB) (IT); Marco Sforzin, Cernusco Sul Naviglio (MI) (IT)

(21) Appl. No.: 19/418,491

(22) Filed: Dec. 12, 2025

Related U.S. Application Data
(60) Provisional application No. 63/737,361, filed on Dec. 20, 2024.

(51) Int. Cl. G06F 3/06

(52) U.S. Cl. CPC G06F 3/0655; G06F 3/0604; G06F 3/0673

(57) ABSTRACT

Methods, systems, and devices for using unreliable memory dies for access operations are described. A memory system may include one or more ranks that each include a plurality of memory dies that are connected to a common chip select. When accessing the memory system, data may be read from or written to a codeword that includes memory cells from multiple (e.g., two) ranks. In some instances, the size of data read from and written to the memory system may be such that some ranks may not need to be fully populated (e.g., a rank could include fewer memory dies than other ranks). Because the memory dies may not be individually accessible, the memory system may fully populate some ranks using less reliable or otherwise defective memory dies whose logic and I/Os are functional.

### CROSS REFERENCE

The present application for patent claims priority to U.S. Patent Application No. 63/737,361 by Corna et al., entitled “USING UNRELIABLE MEMORY DIES FOR ACCESS OPERATIONS,” filed Dec. 20, 2024, which is assigned to the assignee hereof, and which is expressly incorporated by reference in its entirety herein.

### TECHNICAL FIELD

The following relates to one or more systems for memory, including using unreliable memory dies for access operations.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports using unreliable memory dies for access operations in accordance with examples as disclosed herein.

FIGS. 2A and 2B show examples of memory die configurations that support using unreliable memory dies for access operations in accordance with examples as disclosed herein.

FIGS. 3 and 4 show examples of process flows that support using unreliable memory dies for access operations in accordance with examples as disclosed herein.

FIGS. 5 and 6 show block diagrams of memory systems that support using unreliable memory dies for access operations in accordance with examples as disclosed herein.

FIGS. 7 and 8 show flowcharts illustrating a method or methods that support using unreliable memory dies for access operations in accordance with examples as disclosed herein.

### DETAILED DESCRIPTION

A memory system may be associated with various memory die package configurations. In some instances, a memory system may include one or more ranks that each include one or more (e.g., a plurality) of memory dies that are connected to a common chip select. When accessing the memory system, data may be read from or written to a codeword that corresponds to memory cells from multiple (e.g., two) ranks. In some instances, the size of data read from and written to the memory system may be such that some ranks may be partially populated (e.g., some ranks may have fewer memory dies populated compared to others). For example, a codeword may be associated with two ranks and the size of the codeword may be associated with accessing a quantity of data (e.g., 256B data, 48B parity) that would otherwise allow for partially populated ranks (e.g., ten memory dies in one rank, nine memory dies in another rank). However, some memory systems may not support individually addressable memory dies (e.g., the memory system may not support a per-DRAM addressability (PDA) mode), thus partially populated ranks may result, which lead to signal integrity issues, thus decreasing the overall performance of the memory system. Accordingly, a memory system configured to have partially populated ranks, but without experiencing signal integrity and performance degradation issues, may be desirable.

A memory system that utilizes defective or otherwise partially functional (e.g., unreliable) memory dies in one or more ranks is described herein. In some examples, a memory system may support one or more partially populated ranks based on the size of a codeword (e.g., based on the size of data read from and written to the memory system). For example, a memory system may include a first rank that includes a quantity (e.g., ten) reliable memory dies (e.g., memory dies that may be reliably read from and written to) and a second rank that includes another quantity (e.g., nine) reliable memory dies. The first and second ranks may be associated with a single codeword in some examples.

To mitigate signal integrity and termination issues that would otherwise arise due to the second rank being partially populated (e.g., less than all the dies of the second rank being fully reliably read from and written to), the second rank may include a defective memory die (e.g., an unreliable memory die). As used herein, an unreliable or otherwise defective memory die may refer to a memory die whose logic and input/outputs (I/Os) are functional but may otherwise unreliably store data. By including at least one unreliable memory die in a rank, the rank associated with a codeword may be fully populated instead of only being partially populated otherwise, thus mitigating signal integrity and performance degradation issues that would otherwise occur with a partially populated rank. Additionally, the use of unreliable memory dies may reduce the overall cost of the memory system by utilizing memory dies that may otherwise be unusable (e.g., instead of fully functional memory dies).

In addition to applicability in memory systems as described herein, techniques for using unreliable memory dies for access operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by mitigating signal integrity and performance degradation issues that would otherwise occur with partially populated ranks, among other benefits.

In addition to applicability in memory systems as described herein, techniques for using unreliable memory dies for access operations may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by utilizing memory dies that would otherwise be discarded, which may reduce the overall cost of a memory system, among other benefits.

Features of the disclosure are illustrated and described in the context of systems and architectures. Features of the disclosure are further illustrated and described in the context of memory die configurations, process flows, block diagrams, and flowcharts.

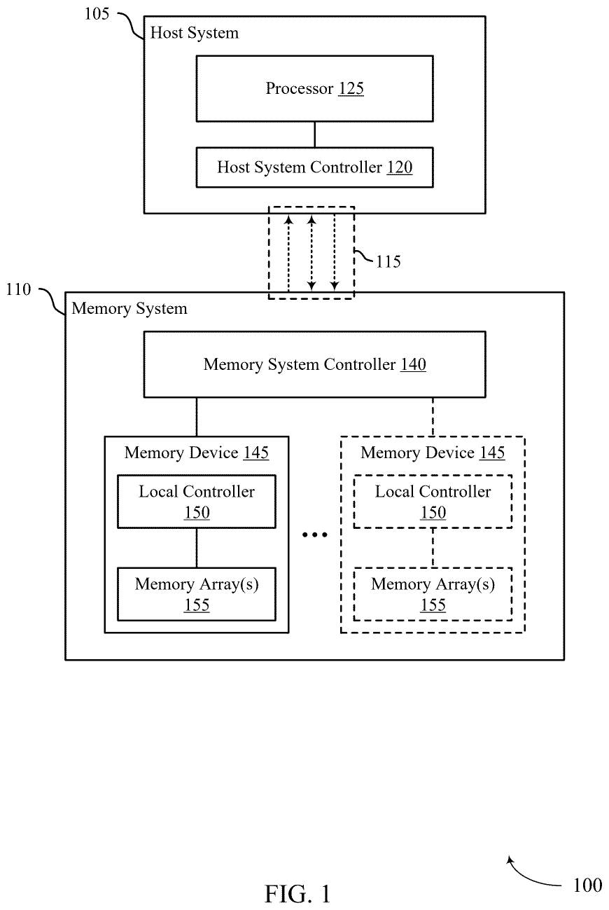

FIG. 1 shows an example of a system 100 that supports using unreliable memory dies for access operations in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not- or (NOR) memory cells, and not- and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

The memory system 110 may utilize defective or otherwise partially functional (e.g., unreliable) memory dies in one or more ranks. In some examples, the memory system 110 may support one or more partially populated ranks based on the size of a codeword (e.g., based on the size of data read from and written to the memory system). For example, the memory system 110 may include a first rank that includes ten reliable memory dies (e.g., memory dies that may be reliably read from and written to) and a second rank that includes nine reliable memory dies. The first and second ranks may be associated with a single codeword.

To mitigate signal integrity and termination issues that would otherwise arise due to the second rank being partially populated in nine dies instead of ten dies, the second rank may include (e.g., be allocated) an unreliable memory die. As used herein, an unreliable memory die may refer to a memory die whose logic and I/Os are functional but may otherwise unreliably store data. By including at least one unreliable memory die in a rank, the rank associated with a codeword may be fully populated instead of only being partially populated otherwise, thus mitigating signal integrity and performance degradation issues that would otherwise occur with a partially populated rank.

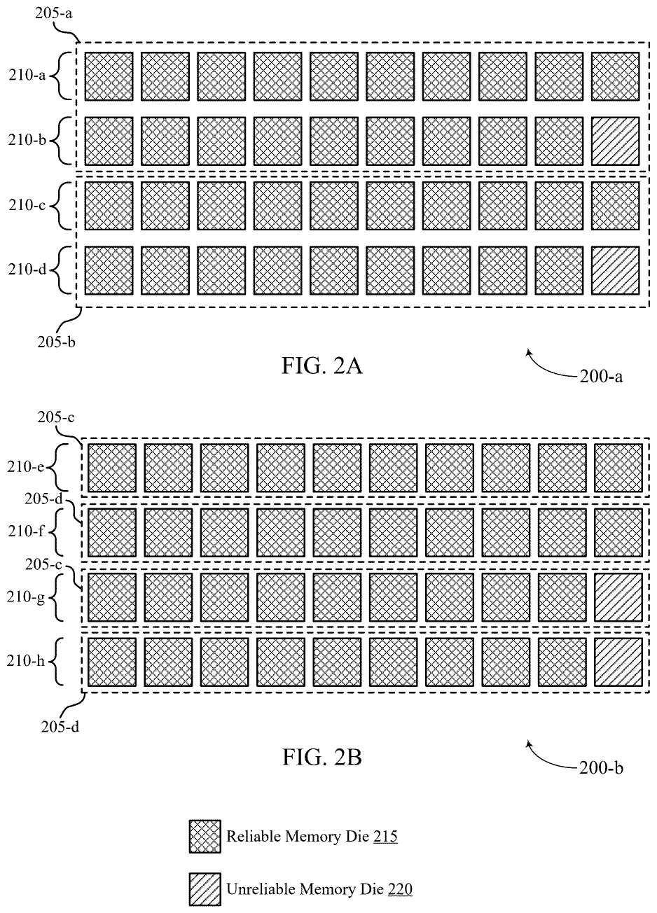

FIGS. 2A and 2B illustrate examples of memory die configurations 200 that support using unreliable memory dies for access operations in accordance with examples as disclosed herein. The memory die configurations 200 may be implemented by or include examples of a memory system 110 or one or more components thereof (e.g., memory dies included in a memory device 145). The memory die configurations 200 may support the use of one or more unreliable memory dies in a rank 210, which may mitigate signal integrity and performance degradation issues that would otherwise occur with partially populated ranks.

The memory die configurations 200 may include one or more ranks 210. Each rank 210 may include multiple memory dies (e.g., reliable memory dies 215, unreliable memory dies 220), and each of the memory die configurations 200 may include or be examples of die packages. For example, the memory die configuration 200-a may include multiple quad-die packages (QDPs), where each QDP may include four memory dies across four ranks 210. While codewords 205 may be discussed herein as being associated with two ranks 210 of memory dies, mapping of the codeword 205 and the use and presence of unreliable memory dies 220 may vary according to the memory system.

A memory system may be associated with various memory die configurations 200. In some instances, a memory system may include one or more ranks 210 that each include a plurality of memory dies that are connected to a common chip select. When accessing the memory system, data may be read from or written to a codeword that includes memory cells from multiple (e.g., two) ranks 210. In some instances, the size of data read from and written to the memory system may be such that some ranks may be partially populated (e.g., some ranks may include fewer memory dies than others). For example, a codeword 205 may be associated with two ranks 210 and the size of the codeword may be associated with accessing a quantity of data (e.g., 256B data, 48B parity) that would otherwise allow for partially populated ranks 210 (e.g., ten memory dies in one rank, nine memory dies in another rank). However, some memory systems may not support individually addressable memory dies (e.g., the memory system may not support a PDA mode), thus partially populated ranks 210 may result in signal integrity issues, which will decrease the overall performance of the memory system.

Accordingly, the memory die configurations 200 may mitigate any signal integrity issues and performance degradation by utilizing at least one unreliable memory die 220 per associated codeword 205. For example, a memory die configuration 200 may include a first rank 210-a that includes a quantity (e.g., ten dies) of reliable memory dies 215 (e.g., memory dies that may be reliably read from and written to) and a second rank 210-b that includes another quantity (e.g., nine dies) of reliable memory dies 215. The first rank 210-a and the second rank 210-b may be associated with a single codeword 205-a.

To mitigate signal integrity and termination issues that would otherwise arise due to the second rank 210-b being partially populated, the second rank 210-b may be configured to include an unreliable memory die 220 whose logic and input/outputs (I/Os) are functional but may otherwise unreliably store data. By including at least one unreliable memory die 220 in a rank 210, the rank 210 associated with a codeword may be fully populated instead of only being partially populated otherwise, thus mitigating signal integrity and performance degradation issues that would otherwise occur with a partially populated rank

In some examples, the memory system may identify an unreliable memory die 220 by detecting a quantity of errors of a memory die that satisfies a threshold value and subsequently mapping a codeword to ranks 210 that include an unreliable memory die 220. In other examples, the memory system may identify an unreliable memory die 220 by detecting a threshold quantity of access failures within a duration, by detecting that associated access timings may fail to satisfy a threshold, or a combination thereof. In other examples, unreliable memory dies may be included in a memory system knowingly during manufacturing. In some examples, the unreliable memory dies 220 may not be suitable for storage of data, but may include operable (e.g., functional) I/Os.

The memory system may use both the reliable memory dies 215 and the unreliable memory dies 220 during access operations. The memory system may perform write operations at one or more memory dies of the ranks 210. For example, in response to receiving a write command indicating data (e.g., associated with a codeword 205) to be written to the ranks 210, the memory system may drive the channels coupled with the memory dies of the ranks 210 associated with the codeword 205 to a write voltage. By driving the channel(s) to the write voltage, the memory system may successfully write data to the reliable memory dies 215 and may attempt (e.g., successfully, unsuccessfully) to write the data to the at least one unreliable memory die 220. For example, as illustrated in FIG. 2A, the memory system may write data to the reliable memory dies 215 of the rank 210-a associated with the codeword 205-a and the reliable memory dies 215 of the rank 210-b associated with the codeword 205-a, and may attempt to write data to the unreliable memory die 220 of the rank 210-b associated with the codeword 205-a. In some examples, the memory system may write dummy data to the unreliable memory dies 220 during a write operation or may merely drive the associated channels to the write voltage to mitigate potential signal integrity or termination issues.

The memory system may perform read operations at one or more memory dies of the ranks 210. For example, in response to receiving a read command indicating data (e.g., associated with a codeword 205) to be read from the ranks 210, the memory system may access the channels coupled with the memory dies of the ranks 210 associated with the codeword 205. The memory system may read data from both the reliable memory dies 215 and from the at least one unreliable memory die 220. However, the memory system may refrain from transmitting the data read from the at least one unreliable memory die 220 to a host system (e.g., due to the data being corrupt or unreliable, or due to a relatively high likelihood that the data is corrupt or unreliable).

For example, as illustrated in FIG. 2A, the memory system may read data from the reliable memory dies 215 of the rank 210-a associated with the codeword 205-a and the unreliable memory die 220 of the rank 210-b associated with the codeword 205-a. The memory system may transmit the data read from the reliable memory dies 215 of the rank 210-a and the rank 210-b, but may refrain from transmitting the data read from the unreliable memory die 220 of the rank 210-b. Due to the quantity of data read from the reliable memory dies 215, the memory system need not pad the data (e.g., with dummy or filler data) before transmitting it to a host system.

FIG. 2A illustrates an example of a memory die configuration 200-a that supports using unreliable memory dies for access operations in accordance with examples as disclosed herein. The memory die configuration 200-a may be implemented by or include examples of a memory system 110 or one or more components thereof (e.g., memory dies included in a memory device 145). A memory system may perform access operations using the memory die configuration 200-a as further described herein.

The memory die configuration 200-a may be an example in which codewords 205 may be mapped to adjacent ranks 210 of a multi-die package (e.g., including multiple QDPs). For example, the memory system (e.g., a memory system controller 140 as described with reference to FIG. 1) may determine that one or more of the ranks 210 include unreliable memory dies 220. The memory system may determine that the rank 210-b and the rank 210-d may include the unreliable memory dies 220. In response to determining the rank 210-b and the rank 210-d to be non-adjacent, the memory system may map a first codeword 205-a to the memory dies of the rank 210-a and the rank 210-b such that the codeword 205-a may be associated with multiple reliable memory dies 215 and the unreliable memory die 220 of the adjacent ranks 210. Additionally, or alternatively, the memory system may map a second codeword 205-b to the memory dies of the rank 210-c and the rank 210-d such that the codeword 205-b may be associated with multiple reliable memory dies 215 and the unreliable memory die 220 of the adjacent ranks 210.

FIG. 2B illustrates an example of a memory die configuration 200-b that supports using unreliable memory dies for access operations in accordance with examples as disclosed herein. The memory die configuration 200-b may be implemented by or include examples of a memory system 110 or one or more components thereof (e.g., memory dies included in a memory device 145). A memory system may perform access operations using the memory die configuration 200-b as further described herein.

The memory die configuration 200-b may be an example in which codewords 205 may be mapped to non-adjacent ranks 210 of a multi-die package (e.g., including multiple QDPs). For example, the memory system (e.g., a memory system controller 140 as described with reference to FIG. 1) may determine that one or more of the ranks 210 include unreliable memory dies 220. The memory system may determine that the rank 210-g and the rank 210-h include the unreliable memory dies 220. In response to determining the rank 210-g and the rank 210-h to be adjacent, the memory system may map a first codeword 205-c to the memory dies of the rank 210-e and the rank 210-g such that the codeword 205-c may be associated with multiple reliable memory dies 215 and the unreliable memory die 220 of the non-adjacent ranks 210. Additionally, or alternatively, the memory system may map a second codeword 205-d to the memory dies of the rank 210-f and the rank 210-h such that the codeword 205-d may be associated with multiple reliable memory dies 215 and the unreliable memory die 220 of the non-adjacent ranks 210.

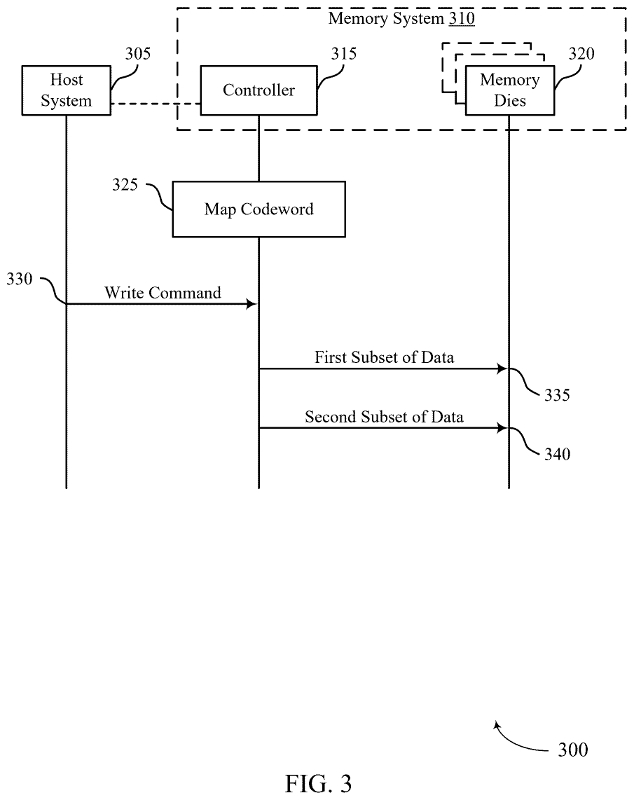

FIG. 3 shows an example of a process flow 300 that supports using unreliable memory dies for access operations in accordance with examples as disclosed herein. The operations of process flow 300 may be performed by a memory system or one or more controllers (e.g., memory system controllers 140) associated with a memory system as described herein. For example, the process flow 300 may illustrate exchanges of data and commands between one or more memory dies 320 and a controller 315 within a memory system 310, and between the memory system 310 and a host system 305, which may represent examples of corresponding systems and dies as described with reference to FIGS. 1 and 2.

At 325, the controller 315 of the memory system 310 may perform a mapping operation. The mapping operation may include the controller 315 mapping a codeword to one or more ranks of the memory dies 320. For example, the controller 315 may map a codeword to a first rank of a memory die of the memory dies 320 and to a second rank of the memory die. In some examples, the first rank and the second rank may be physically adjacent (e.g., the codeword may be mapped to adjacent ranks). In some other examples, the first rank and the second rank may be separated by one or more ranks. For example, the first rank and the second rank may be separated by and adjacent to a third rank. The ranks may be included in a multiple-die package of the memory system 310, which may include the memory dies 320.

At 330, the host system 305 may transmit, and the controller 315 of the memory system 310 may receive a write command. The write command may command the controller 315 to write data to the memory dies 320 of the memory system 310. The data may be associated with the codeword that the controller 315 mapped to the first rank and the second rank of the memory system 310 (e.g., mapped to one or more of the memory dies 320 of the first rank and second rank).

At 335, the controller 315 may write a first subset of data to one or more of the memory dies 320. For example, based on mapping the codeword to the first rank and in response to receiving the write command, the controller 315 may write a first subset of the data associated with the write command to the portion of the memory dies 320 included in the first rank. In some examples, the memory dies 320 of the first rank may be associated with a first type of memory die, which may be an example of a non-defective (e.g., reliable) memory die. To write the first subset of the data to the memory dies 320 of the first rank, the controller 315 may drive one or more channels coupled with the memory dies 320 of the first rank to a write voltage.

At 340, the controller 315 may write a second subset of data to one or more of the memory dies 320. For example, based on mapping the codeword to the second rank and in response to receiving the write command, the controller 315 may write a second subset of the data associated with the write command to the portion of the memory dies 320 included in the second rank. In some examples, multiple of the memory dies 320 of the second rank may be associated with the first type of memory die (e.g., may be non-defective memory dies), and one or more of the memory dies 320 of the second rank may be associated with a second type of memory die, which may be an example of an unreliable memory die. In some examples, the memory dies 320 that may be the second type of memory die may be associated with a threshold quantity of uncorrectable errors, a threshold quantity of access failures within a duration, access timings that may fail to satisfy a threshold, or any combination thereof.

To write the second subset of the data to the memory dies 320 of the second rank (e.g., at 340), the controller 315 may drive one or more channels coupled with the memory dies 320 of the second rank to the write voltage. In a case that the memory dies 320 of the second rank that are associated with the second type (e.g., the unreliable memory dies) may be operable, the controller 315 may successfully write data to the memory dies 320 of the second type. In a case that the memory dies 320 of the second rank that are associated with the second type (e.g., the unreliable memory dies) may be defective (e.g., inoperable), the controller 315 may attempt to write data to the memory dies 320 of the second type, but may be unsuccessful. In some examples, the controller 315 may write the first subset of data to the memory dies 320 and the second subset of data to the memory dies 320 during non-overlapping (e.g., consecutive) durations. For example, the controller 315 may write the first subset of data to the memory dies 320 during a first duration and may write the second subset of data to the memory dies 320 during a second duration that may not be overlapping the first duration in time.

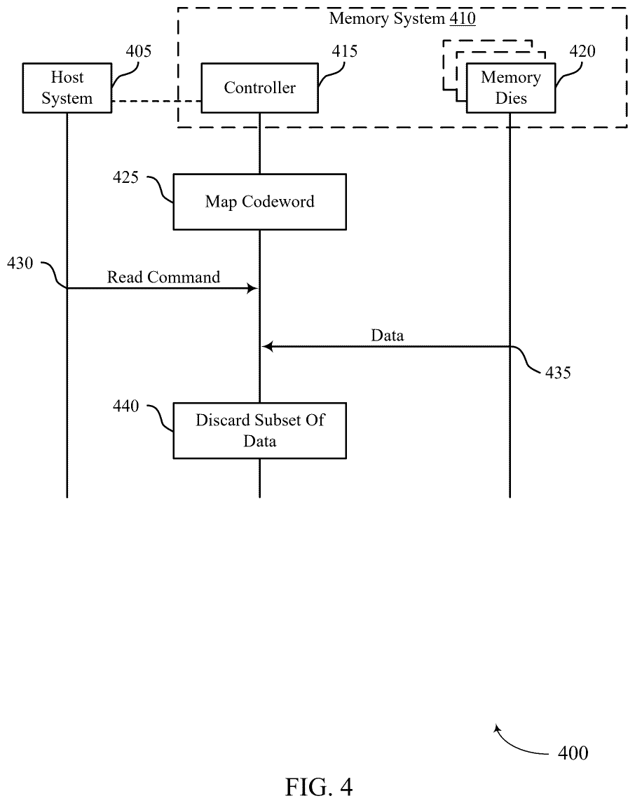

FIG. 4 shows an example of a process flow 400 that supports using unreliable memory dies for access operations in accordance with examples as disclosed herein. The operations of process flow 400 may be performed by a memory system or one or more controllers (e.g., memory system controllers 140) associated with a memory system as described herein. For example, the process flow 400 may illustrate exchanges of data and commands between one or more memory dies 420 and a controller 415 within a memory system 410, and between the memory system 410 and a host system 405, which may represent examples of corresponding systems and dies as described with reference to FIGS. 1 and 2.

At 425, the controller 415 of the memory system 410 may perform a mapping operation. The mapping operation may include the controller 415 mapping a codeword to one or more ranks of the memory dies 420. For example, the controller 415 may map a codeword to a first rank of a memory die of the memory dies 420 and to a second rank of the memory die. In some examples, the first rank and the second rank may be physically adjacent (e.g., the codeword may be mapped to adjacent ranks). In some other examples, the first rank and the second rank may be separated by one or more ranks. For example, the first rank and the second rank may be separated by and adjacent to a third rank. The ranks may be included in a multiple-die package of the memory system 410, which may include the memory dies 420.

At 430, the host system 405 may transmit, and the controller 415 of the memory system 410 may receive, a read command. The read command may command the controller 415 to read data from the memory dies 420 of the memory system 410. The data may be associated with the codeword that the controller 415 mapped to the first rank and the second rank of the memory system 410 (e.g., mapped to one or more of the memory dies 420 of the first rank and second rank).

At 435, the controller 415 may read data from one or more of the memory dies 420. For example, based on mapping the codeword to the first rank and the second rank, and in response to receiving the read command, the controller 415 may read a first subset of the data associated with the read command from the portion of the memory dies 420 included in the first rank and may read a second subset of the data associated with the read command from the portion of the memory dies 420 included in the second rank. In some examples, the memory dies 420 of the first rank may be associated with a first type of memory die, which may be an example of a non-defective (e.g., reliable) memory die. Multiple memory dies of the memory dies 420 of the second rank may be associated with the first type of memory die (e.g., may be non-defective, reliable memory dies), and one or more of the memory dies 420 of the second rank may be associated with a second type of memory die, which may be an example of an unreliable memory die. In some examples, the memory dies 420 that may be the second type of memory die may be associated with a threshold quantity of uncorrectable errors, a threshold quantity of access failures within a duration, access timings that may fail to satisfy a threshold, or any combination thereof.

At 440, the controller may discard one or more subsets of data read from the memory dies 420. For example, based on reading the data from the memory dies 420, the controller 415 may discard a subset of the data read from the one or more memory dies 420 associated with the second type (e.g., data read from the unreliable memory dies). To discard the data, the controller 415 may refrain from transmitting (e.g., to a host system) the data read from the second type of the memory dies 420. The controller 415 of the memory system 410 may not discard the data read from the first type of the memory dies 420, and may transmit the data read from the first type of the memory dies 420 to the host system.

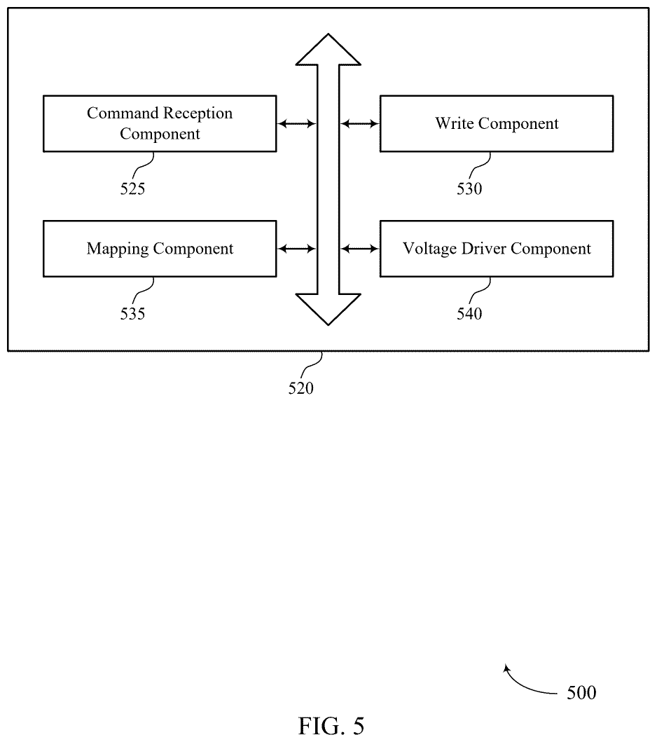

FIG. 5 shows a block diagram 500 of a memory system 520 that supports using unreliable memory dies for access operations in accordance with examples as disclosed herein. The memory system 520 may be an example of aspects of a memory system as described with reference to FIGS. 1 through 4. The memory system 520, or various components thereof, may be an example of means for performing various aspects of using unreliable memory dies for access operations as described herein. For example, the memory system 520 may include a command reception component 525, a write component 530, a mapping component 535, a voltage driver component 540, or any combination thereof. Each of these components, or components of subcomponents thereof (e.g., one or more processors, one or more memories), may communicate, directly or indirectly, with one another (e.g., via one or more buses).

The command reception component 525 may be configured as or otherwise support a means for receiving a command to write data to the memory system, the data associated with a codeword. The write component 530 may be configured as or otherwise support a means for writing a first subset of the data to a first plurality of memory dies of a first rank of the memory system that is associated with the codeword based on receiving the command, the first plurality of memory dies including memory dies of a first type. In some examples, the write component 530 may be configured as or otherwise support a means for writing a second subset of the data to a second plurality of memory dies of a second rank of the memory system that is associated with the codeword based on receiving the command, the second plurality of memory dies including memory dies of the first type and at least one memory die of a second type having a first channel that is driven to a write voltage when writing the second subset of the data.

In some examples, the mapping component 535 may be configured as or otherwise support a means for mapping the codeword to the first rank of the memory system and to the second rank of the memory system prior to receiving the command, where writing the first subset of the data to the first plurality of memory dies of the first rank and writing the second subset of the data to the second plurality of memory dies of the second rank is based on mapping the codeword to the first rank and to the second rank.

In some examples, to support writing the first subset of the data to the first plurality of memory dies of the first rank and writing the second subset of the data to the second plurality of memory dies of the second rank, the voltage driver component 540 may be configured as or otherwise support a means for driving a plurality of channels coupled with the first plurality of memory dies and the second plurality of memory dies to the write voltage, the plurality of channels including the first channel.

In some examples, driving the plurality of channels to the write voltage is associated with attempting to write data to the at least one memory die of the second type via the first channel.

In some examples, driving the plurality of channels to the write voltage is associated with writing data to the at least one memory die of the second type via the first channel.

In some examples, the at least one memory die of the second type is associated with a threshold quantity of uncorrectable errors, a threshold quantity of access failures within a duration, access timings that fail to satisfy a threshold, or any combination thereof.

In some examples, writing the first subset of the data to the first plurality of memory dies and writing the second subset of the data to the second plurality of memory dies occurs during consecutive durations.

In some examples, the first rank of the memory system and the second rank of the memory system are physically adjacent.

In some examples, the first rank of the memory system and the second rank of the memory system are separated by and adjacent to a third rank of the memory system.

In some examples, the first rank of the memory system and the second rank of the memory system are associated with a multiple-die package of the memory system.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

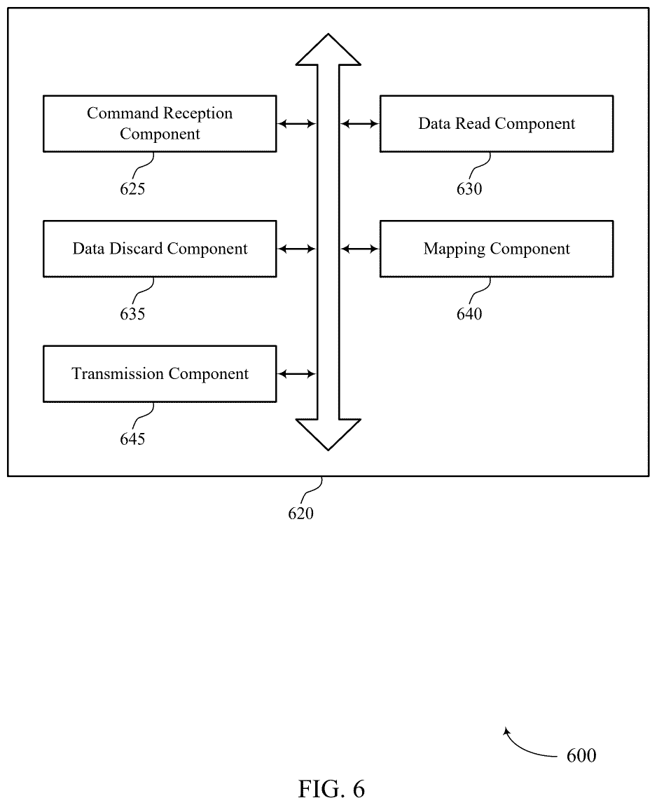

FIG. 6 shows a block diagram 600 of a memory system 620 that supports using unreliable memory dies for access operations in accordance with examples as disclosed herein. The memory system 620 may be an example of aspects of a memory device as described with reference to FIGS. 1 through 4. The memory system 620, or various components thereof, may be an example of means for performing various aspects of using unreliable memory dies for access operations as described herein. For example, the memory system 620 may include a command reception component 625, a data read component 630, a data discard component 635, a mapping component 640, a transmission component 645, or any combination thereof. Each of these components, or components of subcomponents thereof (e.g., one or more processors, one or more memories), may communicate, directly or indirectly, with one another (e.g., via one or more buses).

The command reception component 625 may be configured as or otherwise support a means for receiving a command to read data from the memory system, the data associated with a codeword. The data read component 630 may be configured as or otherwise support a means for reading the data from a first plurality of memory dies of a first rank and a second plurality of memory dies of a second rank of the memory system based on receiving the command, where the first plurality of memory dies of the first rank include memory dies of a first type and the second plurality of memory dies of the second rank include memory dies of the first type and at least one memory die of a second type. The data discard component 635 may be configured as or otherwise support a means for discarding a subset of the data read from the at least one memory die of the second type based on reading the data.

In some examples, the mapping component 640 may be configured as or otherwise support a means for mapping the codeword to the first rank of the memory system and to the second rank of the memory system prior to receiving the command, where reading the data from the first plurality of memory dies of the first rank and the data from the second plurality of memory dies of the second rank is based on mapping the codeword to the first rank and to the second rank.

In some examples, to support discarding the subset of the data read from the at least one memory die of the second type, the transmission component 645 may be configured as or otherwise support a means for refraining from transmitting the subset of the data to a host system.

In some examples, the at least one memory die of the second type is associated with a threshold quantity of uncorrectable errors, a threshold quantity of access failures within a duration, access timings that fail to satisfy a threshold, or any combination thereof.

In some examples, the first rank of the memory system and the second rank of the memory system are physically adjacent.

In some examples, the first rank of the memory system and the second rank of the memory system are separated by and adjacent to a third rank of the memory system.

In some examples, the first rank of the memory system and the second rank of the memory system are associated with a multiple-die package of the memory system.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

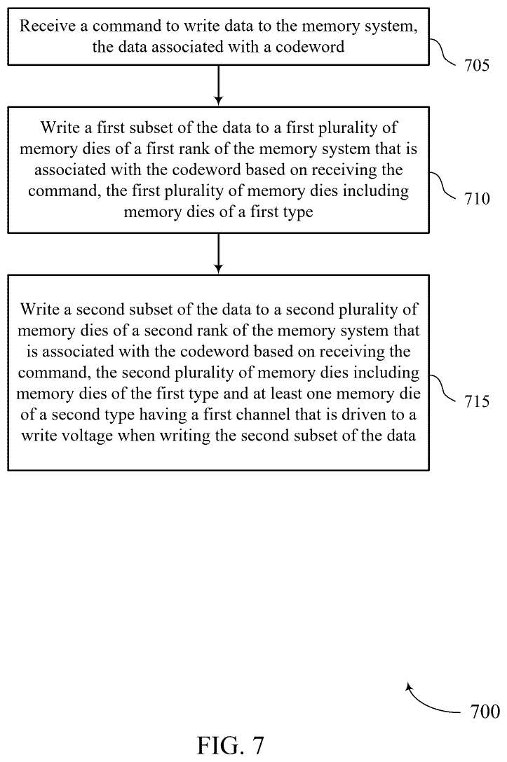

FIG. 7 shows a flowchart illustrating a method 700 that supports using unreliable memory dies for access operations in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include receiving a command to write data to the memory system, the data associated with a codeword. In some examples, aspects of the operations of 705 may be performed by a command reception component 525 as described with reference to FIG. 5. For example, the memory system may be caused to receive a command to write data associated with a codeword 205, including with reference to FIG. 2.

At 710, the method may include writing a first subset of the data to a first plurality of memory dies of a first rank of the memory system that is associated with the codeword based on receiving the command, the first plurality of memory dies including memory dies of a first type. In some examples, aspects of the operations of 710 may be performed by a write component 530 as described with reference to FIG. 5. For example, the memory system may write a first subset of data to the reliable memory dies 215 associated with the codeword 205, including with reference to FIG. 2.

At 715, the method may include writing a second subset of the data to a second plurality of memory dies of a second rank of the memory system that is associated with the codeword based on receiving the command, the second plurality of memory dies including memory dies of the first type and at least one memory die of a second type having a first channel that is driven to a write voltage when writing the second subset of the data. In some examples, aspects of the operations of 715 may be performed by a write component 530 as described with reference to FIG. 5. For example, the memory system may write a second subset of data to the reliable memory dies 215 and to an unreliable memory die 220 associated with the codeword 205, including with reference to FIG. 2.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a command to write data to the memory system, the data associated with a codeword; writing a first subset of the data to a first plurality of memory dies of a first rank of the memory system that is associated with the codeword based on receiving the command, the first plurality of memory dies including memory dies of a first type; and writing a second subset of the data to a second plurality of memory dies of a second rank of the memory system that is associated with the codeword based on receiving the command, the second plurality of memory dies including memory dies of the first type and at least one memory die of a second type having a first channel that is driven to a write voltage when writing the second subset of the data.

Aspect 2: The method, apparatus, or non-transitory computer-readable medium of aspect 1, further including operations, features, circuitry, logic, means, or instructions, or any combination thereof for mapping the codeword to the first rank of the memory system and to the second rank of the memory system prior to receiving the command, where writing the first subset of the data to the first plurality of memory dies of the first rank and writing the second subset of the data to the second plurality of memory dies of the second rank is based on mapping the codeword to the first rank and to the second rank.

Aspect 3: The method, apparatus, or non-transitory computer-readable medium of any of aspects 1 through 2, where writing the first subset of the data to the first plurality of memory dies of the first rank and writing the second subset of the data to the second plurality of memory dies of the second rank further includes operations, features, circuitry, logic, means, or instructions, or any combination thereof for driving a plurality of channels coupled with the first plurality of memory dies and the second plurality of memory dies to the write voltage, the plurality of channels including the first channel.

Aspect 4: The method, apparatus, or non-transitory computer-readable medium of aspect 3, where driving the plurality of channels to the write voltage is associated with attempting to write data to the at least one memory die of the second type via the first channel.

Aspect 5: The method, apparatus, or non-transitory computer-readable medium of any of aspects 3 through 4, where driving the plurality of channels to the write voltage is associated with writing data to the at least one memory die of the second type via the first channel.

Aspect 6: The method, apparatus, or non-transitory computer-readable medium of any of aspects 1 through 5, where the at least one memory die of the second type is associated with a threshold quantity of uncorrectable errors, a threshold quantity of access failures within a duration, access timings that fail to satisfy a threshold, or any combination thereof.

Aspect 7: The method, apparatus, or non-transitory computer-readable medium of any of aspects 1 through 6, where writing the first subset of the data to the first plurality of memory dies and writing the second subset of the data to the second plurality of memory dies occurs during consecutive durations.

Aspect 8: The method, apparatus, or non-transitory computer-readable medium of any of aspects 1 through 7, where the first rank of the memory system and the second rank of the memory system are physically adjacent.

Aspect 9: The method, apparatus, or non-transitory computer-readable medium of any of aspects 1 through 8, where the first rank of the memory system and the second rank of the memory system are separated by and adjacent to a third rank of the memory system.

Aspect 10: The method, apparatus, or non-transitory computer-readable medium of any of aspects 1 through 9, where the first rank of the memory system and the second rank of the memory system are associated with a multiple-die package of the memory system.

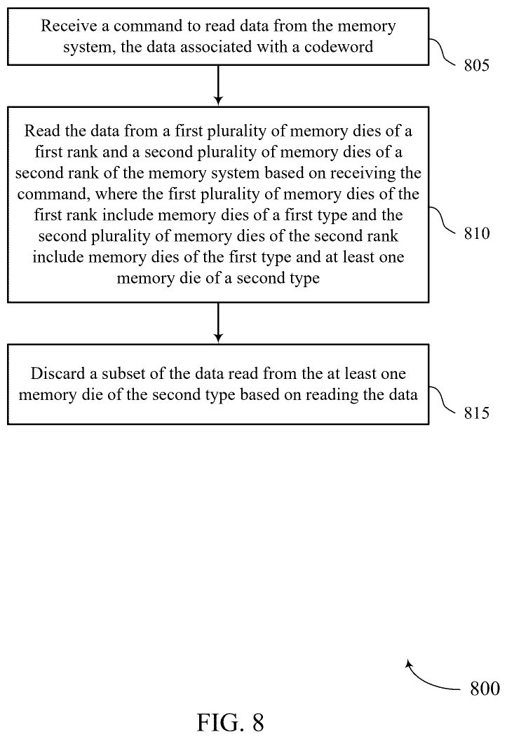

FIG. 8 shows a flowchart illustrating a method 800 that supports using unreliable memory dies for access operations in accordance with examples as disclosed herein. The operations of method 800 may be implemented by a memory device or its components as described herein. For example, the operations of method 800 may be performed by a memory device as described with reference to FIGS. 1 through 4 and 6. In some examples, a memory device may execute a set of instructions to control the functional elements of the device to perform the described functions. Additionally, or alternatively, the memory device may perform aspects of the described functions using special-purpose hardware.

At 805, the method may include receiving a command to read data from the memory system, the data associated with a codeword. In some examples, aspects of the operations of 805 may be performed by a command reception component 625 as described with reference to FIG. 6. For example, the memory system may receive a command to read data associated with a codeword 205, including with reference to FIG. 2.

At 810, the method may include reading the data from a first plurality of memory dies of a first rank and a second plurality of memory dies of a second rank of the memory system based on receiving the command, where the first plurality of memory dies of the first rank include memory dies of a first type and the second plurality of memory dies of the second rank include memory dies of the first type and at least one memory die of a second type. In some examples, aspects of the operations of 810 may be performed by a data read component 630 as described with reference to FIG. 6. For example, the memory system reads data from the reliable memory dies 215 and from the unreliable memory dies 220, including with reference to FIG. 2.

At 815, the method may include discarding a subset of the data read from the at least one memory die of the second type based on reading the data. In some examples, aspects of the operations of 815 may be performed by a data discard component 635 as described with reference to FIG. 6. For example, the memory system may discard data read from the unreliable memory dies 220, including with reference to FIG. 2.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for receiving a command to read data from the memory system, the data associated with a codeword; reading the data from a first plurality of memory dies of a first rank and a second plurality of memory dies of a second rank of the memory system based on receiving the command, where the first plurality of memory dies of the first rank include memory dies of a first type and the second plurality of memory dies of the second rank include memory dies of the first type and at least one memory die of a second type; and discarding a subset of the data read from the at least one memory die of the second type based on reading the data.

Aspect 12: The method, apparatus, or non-transitory computer-readable medium of aspect 11, further including operations, features, circuitry, logic, means, or instructions, or any combination thereof for mapping the codeword to the first rank of the memory system and to the second rank of the memory system prior to receiving the command, where reading the data from the first plurality of memory dies of the first rank and the data from the second plurality of memory dies of the second rank is based on mapping the codeword to the first rank and to the second rank.

Aspect 13: The method, apparatus, or non-transitory computer-readable medium of any of aspects 11 through 12, where discarding the subset of the data read from the at least one memory die of the second type further includes operations, features, circuitry, logic, means, or instructions, or any combination thereof for refraining from transmitting the subset of the data to a host system.

Aspect 14: The method, apparatus, or non-transitory computer-readable medium of any of aspects 11 through 13, where the at least one memory die of the second type is associated with a threshold quantity of uncorrectable errors, a threshold quantity of access failures within a duration, access timings that fail to satisfy a threshold, or any combination thereof.

Aspect 15: The method, apparatus, or non-transitory computer-readable medium of any of aspects 11 through 14, where the first rank of the memory system and the second rank of the memory system are physically adjacent.

Aspect 16: The method, apparatus, or non-transitory computer-readable medium of any of aspects 11 through 15, where the first rank of the memory system and the second rank of the memory system are separated by and adjacent to a third rank of the memory system.

Aspect 17: The method, apparatus, or non-transitory computer-readable medium of any of aspects 11 through 16, where the first rank of the memory system and the second rank of the memory system are associated with a multiple-die package of the memory system.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 18: A memory system, including: a first rank including a first plurality of memory dies of a first type, the first rank associated with a first codeword; and a second rank including a second plurality of memory dies of a first type and at least one memory die of a second type, the second rank associated with the first codeword, where the memory dies of the first type are configured to be read from and written to, and where the at least one memory die of the second type is configured to be read from and are associated with one or more channels configured to be driven to a write voltage during a write operation.

Aspect 19: The memory system of aspect 18, further including: a third rank including a third plurality of memory dies of the first type, the first rank associated with a second codeword, where the first rank of the memory system and the second rank of the memory system are separated by and adjacent to the third rank of the memory system; and a fourth rank including a fourth plurality of memory dies of the first type and at least one memory die of the second type, the second rank associated with the second codeword, where the second rank of the memory system is adjacent to the fourth rank of the memory system.

Aspect 20: The memory system of any of aspects 18 through 19, where the first rank of the memory system and the second rank of the memory system are physically adjacent.

Aspect 21: The memory system of any of aspects 18 through 20, where the second type includes a defective memory die.

Aspect 22: The memory system of any of aspects 18 through 21, where the at least one memory die of the second type is associated with a threshold quantity of uncorrectable errors, a threshold quantity of access failures within a duration, access timings that fail to satisfy a threshold, or any combination thereof.

Aspect 23: The memory system of any of aspects 18 through 22, where the first rank of the memory system and the second rank of the memory system are associated with a multiple-die package of the memory system.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a command to write data to the memory system, the data associated with a codeword;
write a first subset of the data to a first plurality of memory dies of a first rank of the memory system that is associated with the codeword based on receiving the command, the first plurality of memory dies comprising memory dies of a first type; and
write a second subset of the data to a second plurality of memory dies of a second rank of the memory system that is associated with the codeword based on receiving the command, the second plurality of memory dies comprising memory dies of the first type and at least one memory die of a second type having a first channel that is driven to a write voltage when writing the second subset of the data.

2. The memory system of claim 1, wherein the processing circuitry is further configured to cause the memory system to:
map the codeword to the first rank of the memory system and to the second rank of the memory system prior to receiving the command, wherein writing the first subset of the data to the first plurality of memory dies of the first rank and writing the second subset of the data to the second plurality of memory dies of the second rank is based on mapping the codeword to the first rank and to the second rank.

3. The memory system of claim 1, wherein writing the first subset of the data to the first plurality of memory dies of the first rank and writing the second subset of the data to the second plurality of memory dies of the second rank further comprises the processing circuitry configured to cause the memory system to:
drive a plurality of channels coupled with the first plurality of memory dies and the second plurality of memory dies to the write voltage, the plurality of channels comprising the first channel.

4. The memory system of claim 3, wherein driving the plurality of channels to the write voltage is associated with attempting to write data to the at least one memory die of the second type via the first channel.

5. The memory system of claim 3, wherein driving the plurality of channels to the write voltage is associated with writing data to the at least one memory die of the second type via the first channel.

6. The memory system of claim 1, wherein the at least one memory die of the second type is associated with a threshold quantity of uncorrectable errors, a threshold quantity of access failures within a duration, access timings that fail to satisfy a threshold, or any combination thereof.

7. The memory system of claim 1, wherein writing the first subset of the data to the first plurality of memory dies and writing the second subset of the data to the second plurality of memory dies occurs during consecutive durations.

8. The memory system of claim 1, wherein:
the first rank of the memory system and the second rank of the memory system are physically adjacent.

9. The memory system of claim 1, wherein the first rank of the memory system and the second rank of the memory system are separated by and adjacent to a third rank of the memory system.

10. The memory system of claim 1, wherein the first rank of the memory system and the second rank of the memory system are associated with a multiple-die package of the memory system.

11. A memory system, comprising:
one or more memory devices; and
processing circuitry coupled with the one or more memory devices and configured to cause the memory system to:
receive a command to read data from the memory system, the data associated with a codeword;
read the data from a first plurality of memory dies of a first rank and a second plurality of memory dies of a second rank of the memory system based on receiving the command, wherein the first plurality of memory dies of the first rank comprise memory dies of a first type and the second plurality of memory dies of the second rank comprise memory dies of the first type and at least one memory die of a second type; and
discard a subset of the data read from the at least one memory die of the second type based on reading the data.

12. The memory system of claim 11, wherein the processing circuitry is further configured to cause the memory system to:
map the codeword to the first rank of the memory system and to the second rank of the memory system prior to receiving the command, wherein reading the data from the first plurality of memory dies of the first rank and the data from the second plurality of memory dies of the second rank is based on mapping the codeword to the first rank and to the second rank.

13. The memory system of claim 11, wherein discarding the subset of the data read from the at least one memory die of the second type further comprises the processing circuitry configured to cause the memory system to:
refrain from transmitting the subset of the data to a host system.

14. The memory system of claim 11, wherein the at least one memory die of the second type is associated with a threshold quantity of uncorrectable errors, a threshold quantity of access failures within a duration, access timings that fail to satisfy a threshold, or any combination thereof.

15. The memory system of claim 11, wherein:
the first rank of the memory system and the second rank of the memory system are physically adjacent.

16. The memory system of claim 11, wherein the first rank of the memory system and the second rank of the memory system are separated by and adjacent to a third rank of the memory system.

17. The memory system of claim 11, wherein the first rank of the memory system and the second rank of the memory system are associated with a multiple-die package of the memory system.

18. A memory system, comprising:
a first rank comprising a first plurality of memory dies of a first type, the first rank associated with a first codeword; and
a second rank comprising a second plurality of memory dies of a first type and at least one memory die of a second type, the second rank associated with the first codeword, wherein the first plurality of memory dies of the first type are configured to be read from and written to, and wherein the at least one memory die of the second type is configured to be read from and are associated with one or more channels configured to be driven to a write voltage during a write operation.

19. The memory system of claim 18, further comprising:
a third rank comprising a third plurality of memory dies of the first type, the first rank associated with a second codeword, wherein the first rank of the memory system and the second rank of the memory system are separated by and adjacent to the third rank of the memory system; and
a fourth rank comprising a fourth plurality of memory dies of the first type and at least one memory die of the second type, the second rank associated with the second codeword, wherein the second rank of the memory system is adjacent to the fourth rank of the memory system.

20. The memory system of claim 18, wherein the first rank of the memory system and the second rank of the memory system are physically adjacent.

21. The memory system of claim 18, wherein the second type comprises a defective memory die.

22. The memory system of claim 18, wherein the at least one memory die of the second type is associated with a threshold quantity of uncorrectable errors, a threshold quantity of access failures within a duration, access timings that fail to satisfy a threshold, or any combination thereof.

23. The memory system of claim 18, wherein the first rank of the memory system and the second rank of the memory system are associated with a multiple-die package of the memory system.

24. A method at a memory system, comprising:
receiving a command to write data to the memory system, the data associated with a codeword;
writing a first subset of the data to a first plurality of memory dies of a first rank of the memory system that is associated with the codeword based on receiving the command, the first plurality of memory dies comprising memory dies of a first type; and
writing a second subset of the data to a second plurality of memory dies of a second rank of the memory system that is associated with the codeword based on receiving the command, the second plurality of memory dies comprising memory dies of the first type and at least one memory die of a second type having a first channel that is driven to a write voltage when writing the second subset of the data.

25. The method of claim 24, further comprising:
map the codeword to the first rank of the memory system and to the second rank of the memory system prior to receiving the command, wherein writing the first subset of the data to the first plurality of memory dies of the first rank and writing the second subset of the data to the second plurality of memory dies of the second rank is based on mapping the codeword to the first rank and to the second rank.

26. The method of claim 24, wherein writing the first subset of the data to the first plurality of memory dies of the first rank and writing the second subset of the data to the second plurality of memory dies of the second rank comprises:
drive a plurality of channels coupled with the first plurality of memory dies and the second plurality of memory dies to the write voltage, the plurality of channels comprising the first channel.

27. The method of claim 26, wherein driving the plurality of channels to the write voltage is associated with attempting to write data to the at least one memory die of the second type via the first channel.

28. The method of claim 26, wherein driving the plurality of channels to the write voltage is associated with writing data to the at least one memory die of the second type via the first channel.

29. The method of claim 24, wherein the at least one memory die of the second type is associated with a threshold quantity of uncorrectable errors, a threshold quantity of access failures within a duration, access timings that fail to satisfy a threshold, or any combination thereof.

30. A method at a memory system, comprising:
receiving a command to read data from the memory system, the data associated with a codeword;
reading the data from a first plurality of memory dies of a first rank and a second plurality of memory dies of a second rank of the memory system based on receiving the command, wherein the first plurality of memory dies of the first rank comprise memory dies of a first type and the second plurality of memory dies of the second rank comprise memory dies of the first type and at least one memory die of a second type; and
discarding a subset of the data read from the at least one memory die of the second type based on reading the data.
